(19) United States
(12) Patent Application Publication
(10) Pub. No.: US 2021/0048534 A1
(43) Pub. Date: Feb. 18, 2021

(54) SEA CURRENT MEASURING DEVICE FOR SURVIVOR

(71) Applicant: Nthink Co., Ltd., Ulsan (KR)

(72) Inventors: Young-Gwan KANG, Busan (KR); Ki-Sub KANG, Jeonju-si (KR); Young-Hun LEE, Busan (KR)

(73) Assignee: Nthink Co., Ltd., Ulsan (KR)

(21) Appl. No.: 16/836,154

(22) Filed: Mar. 31, 2020

(30) Foreign Application Priority Data
Aug. 13, 2019 (KR) 10-2019-0099002

(51) Int. Cl. G01S 19/14; G01P 5/00

(52) U.S. Cl. CPC G01S 19/14; G01P 5/00

(57) ABSTRACT

A sea current measuring device for a survivor is proposed. More particularly, the sea current measuring device for the survivor, utilizing Global Positioning System (GPS), is capable of helping expedite life-saving activities by estimating a survivor's location through analysis of previously observed tidal flow data and measurement of sea current in real time when a person is lost at sea due to various marine accidents such as drifting, overturning, stranding, sinking, and the like of a vessel, which may occur at all times at sea.

### CROSS REFERENCE TO RELATED APPLICATION

The present application claims priority to Korean Patent Application No. 10-2019-0099002, filed on Aug. 13, 2019, the entire contents of which is incorporated herein for all purposes by this reference.

### BACKGROUND OF THE INVENTION

### Field of the Invention

The present invention relates to a sea current measuring device for a survivor. More particularly, the present invention relates to a sea current measuring device utilizing Global Positioning System (GPS) for a survivor, the device being capable of helping expedite life-saving activities by estimating a survivor's location through analysis of previously observed tidal flow data and measurement of sea currents in real time when any person is lost at sea due to various marine accidents such as drifting, overturning, stranding, sinking, and the like of a vessel, which may occur at any time at sea.

### Description of the Related Art

The International Maritime Organization (IMO) is an international organization that oversees the establishment and revision of practical international standards for maritime safety, security, and maritime pollution prevention. Accordingly, the impact of IMO's decision making in a maritime industry is huge.

The IMO stipulates the Ship Reporting System (SRS) under the Safety of Life at Sea (SOLAS) and the International Convention on Maritime Search and Rescue (SAR) for the purpose of managing vessel traffic and ensuring prompt search and rescue in the event of distress in vessels for effective support in preventing and soothing vessel accidents. Some countries are mandating or arbitrarily implementing such an SRS and are operating the Vessel Monitoring System (VMS) incorporating satellite communication technology into a concept of the SRS for the purpose of safety, and management of fisheries resources.

In Korea, a legal basis for the implementation of the VMS was prepared in the Vessel Safety Act amended on Mar. 24, 2006. On Nov. 1, 2007, “Public notice on installation of vessel position transmitter and others” was announced, and detailed standards on types, installation, and operation of VMS equipment were stipulated. According to this public notice, any vessel of no smaller than a predetermined size is obliged to operate with a VMS system being installed therein.

In addition, with the introduction of a Global Maritime Distress and Safety System (GMDSS), a distress communication method in the sea is changing from an existing distress communication method by a wireless telephone to a distress communication method by Digital Selective Calling (DSC). In Korea, various radio stations, such as fishing information communication stations, port operations service coast stations, and the like including rescue radio stations for rescue radio communication are independently operated for unique tasks thereof.

However, most coast radio stations are still operating mainly for receiving distress signals by conventional voice calls, and have not been linked with each of the radio stations.

In addition, for large-sized vessels provided with the GMDSS, it is possible to perform a rescue in a short time because the position information may be immediately provided by satellite Emergency Position Indication Radio Beacons (EPIRB) in the case of distress. However, small-sized vessels (non-GMDSS vessels) accounting for a majority of disastrous sea accidents are not obliged to mount EPIRBs, thereby having no automatic notification means that is available in the case of distress. Accordingly, as a matter of fact, the small-sized vessels must report a distress situation using a fishing radio or a mobile phone.

However, the fishing radio and the mobile phone may not play a sufficient role as a means of contact during distress as there may be signal dead zones in the far-off sea, for example.

In addition, the aforementioned equipment such as the EPIRB and the like has problems of being expensive, of requiring high maintenance costs, and of being difficult to carry because the equipment is large.

On the other hand, in regard to the provision of radio facilities installation standards and distress system for vessels according to the SOLAS agreement and the domestic vessel safety law, the large-sized vessels follow the GMDSS system according to international agreements. However, as fishing boats follow a separate radio system from the GMDSS, no mutual communication means exists in fact between the fishing boats and large-sized vessels due to different wireless communication systems.

In addition, taking a look at a status in terms of occurrences of domestic marine accidents in Korean waters, the number of marine accidents of vessels no greater than 5 tons accounted for 257 cases or 34% among the number (767 cases in 2008) of marine accidents of vessels in 2008.

In the case of small-sized fishing boats no greater than 5 tons, mostly one person or husband and wife are involved in the work, and most of the workers are aged. Accordingly, when an emergency situation occurs, the workers are prone to fail to promptly respond to the situation, whereby the situation mostly leads to a mortality accident.

Taking a look at the types of accidents of small-sized fishing boats, most cases are attributed to accidents in which a fisherman falls into the sea when parts of the body thereof such as ankle and the like are wrapped in a rope while casting a fishing net alone, or when physical energy of the person is run out.

In addition, when a married couple works on a small fishing boat less than one ton, and then a big wave suddenly comes, a woman with poor coping ability falls into the sea and is lost.

Such small-sized fishing boats operate 2 to 3 miles (about 5 km) from land but in events of various accidents, most of the boats are lost and lead to mortality accidents as assistance is not provided in the vicinity.

Marine accidents of such small-sized boats are directly related to human safety, thus require prompt rescue. However, since a small-sized boat is not equipped with an automatic rescue transmission system such as EPIRB, there is a problem that it is difficult to expect prompt rescue due to the difficulty of identifying distress facts and locating distress positions.

In addition, since passengers falling overboard from a vessel as well as the accidents of small-sized boats are unable to be determined, searching for the missing passengers in the event of a vessel accident is difficult.

For example, in the case of the Dongchang-ho on the sea of Woo-do of Jeju Island, the case being taken place on Feb. 5, 2010, two people were dead and four people were missing. At that time, 11 maritime patrol boats and five fisheries guidance vessels were dispatched to the scene, and two units such as a helicopter and an aircraft extensively searched the large area. However, only floating items such as ropes and the like were identified, and no missing persons were found. Therefore, it is urgent to develop a system that is able to identify an accident occurrence and to search for survivors in the case of an accident in which passengers fall from a vessel.

In other words, in the event of a maritime distress accident, the prompt identification of the location of the survivors is the most important factor in search and rescue activities. Existing search and rescue activities are carried out by anticipating the point of rescue on the basis of the location identified in a request of the survivors or in a report of a witness to the distress.

However, in the case that a long time has passed in moving to the point where the distress took place, there is technical difficulty in accurately estimating the position of the survivor.

Korean Patent Application Publication No. 10-2015-0129898 discloses a maritime search and rescue system and a maritime search and rescue method using same.

The foregoing is intended merely to aid in the understanding of the background of the present invention, and is not intended to mean that the present invention falls within the purview of the related art that is already known to those skilled in the art.

### DOCUMENTS OF RELATED ART

### Patent Document

Korean Patent Application Publication No. 10-2015-0129898 (Publication date: Nov. 23, 2015), entitled Maritime Search and Rescue System.

### SUMMARY OF THE INVENTION

Accordingly, the present invention has been made to solve the problems described above, and the objective of the present invention is to provide a sea current measuring device utilizing Global Positioning System (GPS) for a survivor, the device being capable of helping expedite life-saving activities by estimating a survivor's location through analysis of previously observed tidal flow data and measurement of sea currents in real time when any person is lost at sea due to various marine accidents such as drifting, overturning, stranding, sinking, and the like of a vessel, which may occur at any time at sea.

The objectives of the embodiments of the present invention are not limited to the above-mentioned objectives, and other objectives not mentioned will be clearly understood by those skilled in the art from the following description.

In order to achieve the above objectives according to one embodiment of the present invention, there may be provided a sea current measuring device for a survivor, the device including: a transmitter 100 configured to transmit GPS data obtained from GPS mounted thereon using LoRa (Long Range) communication; a receiver 200 configured to calculate a moving distance of the sea current, moving speed of the sea current, and a moving direction of the sea current on the basis of the GPS data received from the transmitter 100; and a display unit 300 configured to display information related to the GPS data, the moving distance of the sea current, the moving speed of the sea current, and the moving direction of the sea current, thereby allowing a user to visually see the information.

In addition, the transmitter 100 may be equipped with a plurality of GPS units.

In addition, the receiver 200 may be configured to receive the GPS data from the transmitter 100 and, on the basis of the GPS data, to calculate the moving distance of the sea current, the moving speed of the sea current, and the moving direction of the sea current.

In addition, the receiver 200 may be configured to calculate the moving distance of the sea current, the moving speed of the sea current, and the moving direction of the sea current with an average value of the GPS data received from a plurality of transmitters 100.

In addition, the receiver 200 may be configured to assign a weighting to the GPS data according to an extent of density of the transmitters 100, thereby calculating the moving distance of the sea current, the moving speed of the sea current, and the moving direction of the sea current.

In addition, the receiver 200 may be configured to enable collected information and calculated information to be converted and linked to electronic navigation chart data.

In addition, the receiver 200 may be configured to transmit the electronic navigation chart data to an external terminal, and the external terminal may be configured to visually display the electronic navigation chart data.

As described above, according to the sea current measuring device for the survivor according to one embodiment of the present invention, there is an effect that information necessary for the rescue of the survivor such as the moving distance of the sea current, the moving speed of the sea current, the moving direction of the sea current, and the like can be quickly obtained.

In this way, it is possible to quickly determine in which direction and at what speed the survivor is drifting (moving) and to carry out a search by predicting a position of the survivor and setting a search a zone on the basis of the predicted survivor position. Accordingly, there is an effect that a survivor can be found more quickly.

In addition, a plurality of GPS units is mounted in one transmitter, whereby GPS errors can be reduced. Accordingly, there are effects that more accurate information can be obtained.

In addition, the sea current is measured on the basis of information obtained from a plurality of transmitters, whereby there is an effect that more general sea current flows can be identified.

In addition, weighting is used, whereby there is an effect that it is possible to identify the sea current flow along which the survivor is more likely to be moved, from a probabilistic point of view.

In addition, information can be linked to an electronic navigation chart, whereby the information can be confirmed more intuitively. Accordingly, there is an effect that the search can be made more quickly.

In addition, the device can be linked to an external terminal, whereby the search can be performed by separating the sea current measurement team and the survivor search team. Accordingly, there is an effect that a survivor search can be performed more quickly.

In addition, it is also possible to enable the transmitter to float on the surface of the water and to be retrieved by using a drone. Accordingly, there is an effect that a survivor search can be performed more quickly.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a conceptual diagram of a sea current measuring device for a survivor according to an embodiment of the present invention;

FIG. 2 is an exemplary view illustrating an example in which electronic navigation chart data is visually displayed on an external terminal; and

FIG. 3 is a conceptual view illustrating an example in which a transmitter of FIG. 1 is structured to have a lower part provided with a buoy part and an upper part provided with a drone part.

### DETAILED DESCRIPTION OF THE INVENTION

As the present invention allows for various changes and numerous embodiments, particular embodiments will be illustrated in the drawings and described in detail in the written description. However, this is not intended to limit the present invention to specific embodiments, and the present invention should be understood to include all modifications, equivalents, and substitutes included in the spirit and scope thereof.

When a component is said to be “linked” or “connected” to another component, it may be directly linked to or connected to the other component, but it should be understood that a different component may exist therebetween.

On the other hand, when a component is said to be “directly linked” or “directly connected” to another component, it should be understood that there is no other component therebetween.

The term used herein is for the purpose of describing particular embodiments only and is not intended to be limiting of the invention. Singular expressions include plural expressions unless the context clearly indicates otherwise. In this application, the term “comprise” or “having” is intended to indicate that there is a feature, number, process, operation, component, part, or combination thereof described in the specification, and it is to be understood that the present invention does not exclude in advance the possibility of the presence or the addition of one or more other features, numbers, processes, operations, components, parts, or a combination thereof.

Unless defined otherwise, all terms used herein, including technical or scientific terms, have the same meaning as commonly understood by one of ordinary skill in the art.

Terms such as those defined in the commonly used dictionaries should be construed as having meanings consistent with the meanings in the context of the related art and should not be construed in ideal or excessively formal meanings unless expressly defined in this application.

Hereinbelow, exemplary embodiments of the present invention will be described in detail with reference to the accompanying drawings. Prior to this, terms or words used in the present specification and claims should not be construed as having a conventional or dictionary meaning. On the basis of the principle that the concept of terms may be properly defined in order to explain the invention in the best way, the invention should be interpreted as meanings and concepts corresponding to the technical idea thereof. In addition, unless there is another definition in the technical terms and scientific terms used, it has the meaning commonly understood by those of ordinary skill in the art to which the invention belongs, and in the following description and the accompanying drawings, descriptions of well-known functions and configurations that may unnecessarily obfuscate the gist of the invention are omitted. The drawings introduced below are provided by way of example so that the spirit of the invention may be fully conveyed to those skilled in the art. Accordingly, the present invention is not limited to the drawings presented below and may be embodied in other forms. Also, like reference numerals denote like elements throughout the specification. It should be noted that the same elements in the drawings are represented by the same numerals wherever possible.

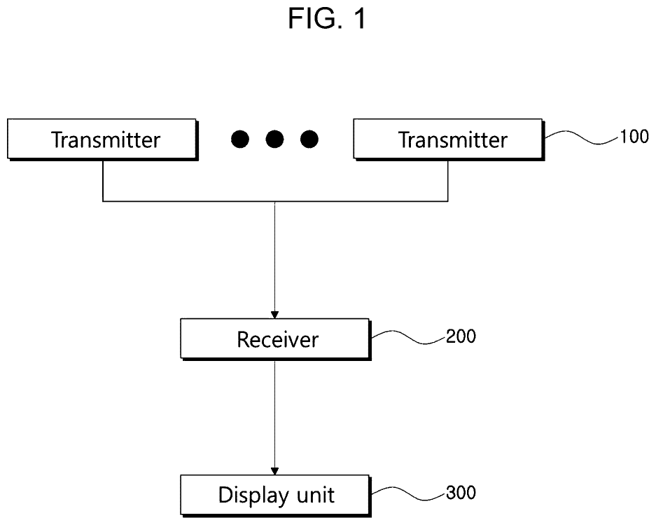

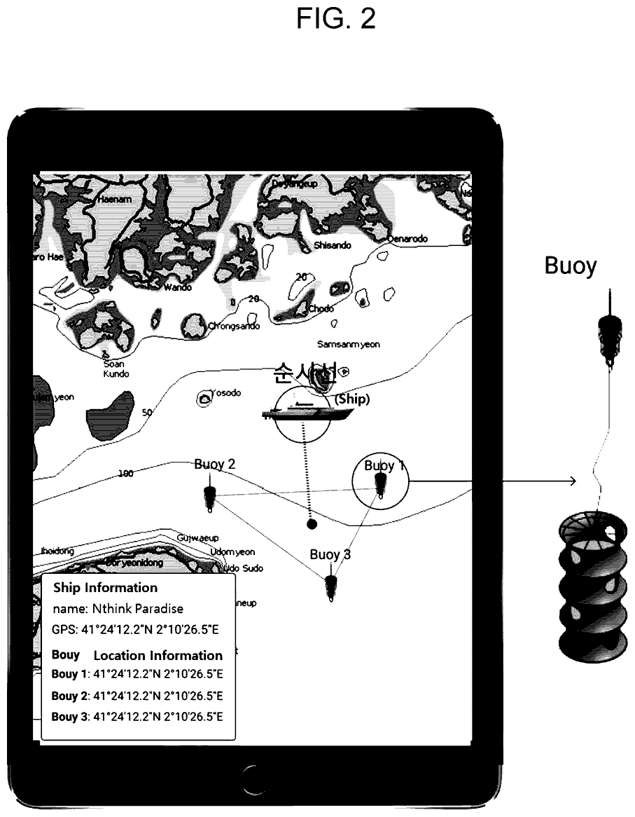

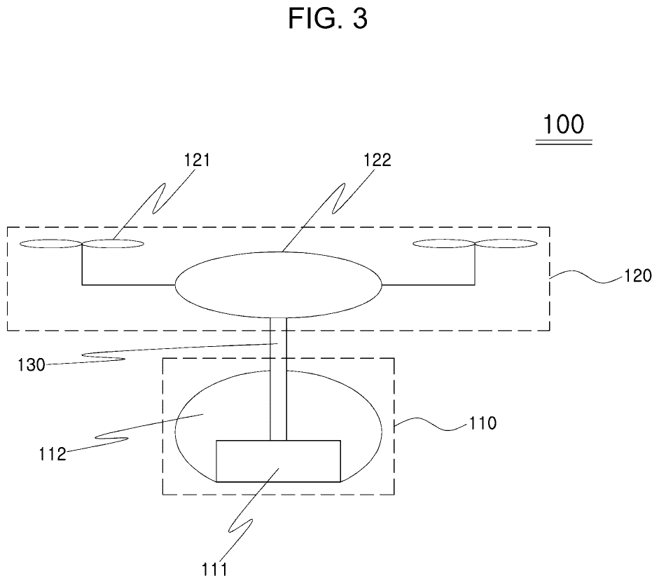

FIG. 1 is a conceptual diagram of a sea current measuring device for a survivor according to an embodiment of the present invention, FIG. 2 is an exemplary view illustrating an example in which electronic navigation chart data is visually displayed on an external terminal, and FIG. 3 is a conceptual view illustrating an example in which the transmitter of FIG. 1 is structured to have a lower part provided with a buoy part and an upper part provided with a drone part.

Prior to the description, terms used in the specification (and claims) will be briefly described.

As used herein, the term “sea current” refers to the flow of seawater, and refers to the movement of seawater, which may change direction or speed at any time.

In general, in the event of distress due to various marine accidents such as drifting, overturning, stranding, sinking, and the like of a vessel, a search zone is set from the spot where the accident took place for the search for survivors, and the search is performed in a predetermined order. Since it takes time to move from the time of the accident to the spot where the accident took place, the survivors may drift and be moved a long distance away from the spot. Accordingly, the later the arrival time to the spot where the accident took place, the longer the search time takes and the longer time it takes to find survivors. As a result, there is a problem that the likelihood of death of the survivors becomes higher.

Therefore, the most important thing when a person is lost at sea is to quickly determine to which direction the survivor is drifting (moving) and at around what speed. Subsequently, a search may be carried out by predicting a position of the survivor and setting the search zone on the basis of the predicted survivor position.

To this end, it is important to identify the movement of the sea current, wherein important information includes information such as a moving distance of the sea current, moving speed of the sea current, a moving direction of the sea current, and the like.

The sea current measuring device for the survivor according to an embodiment of the present invention may quickly obtain information necessary for survivor rescue, such as the moving distance of the sea current, the moving speed of the sea current, the moving direction of the sea current, and the like.

As shown in FIG. 1, the sea current measuring device for the survivor according to the embodiment of the present invention includes a transmitter 100, a receiver 200, and a display unit 300.

The transmitter 100 is configured to transmit GPS data obtained from the GPS mounted thereon using LoRa (Long Range) communication.

That is, the transmitter 100 may obtain GPS data of a point at which the transmitter 100 is located and transmit the GPS data to the receiver 200 which will be described later.

The transmitter 100 is to be floated on a surface of a spot where the accident took place by being dispatched to the accident scene when the survivor occurs due to a marine accident, the transmitter 100 may be implemented in a shape of a buoy.

In this case, the transmitter 100 may be configured to be able to drift.

That is, the transmitter 100 may drift according to the flow of water (sea currents and the like), thereby obtaining GPS data that is information capable of being used as a basis for estimating in which direction the survivor is floating, at a specified time (hourly) or in real time.

At this time, the information may be transmitted through the LoRa communication, which is a low-power long-distance wireless communication technology requiring low standby power and provided at a low module price.

Unlike existing smartphone communication networks such as 3G, Long Term Evolution (LTE), and the like, the LoRa communication is a long-distance communication technology, which (1) transmits and receives small scale data at low power by mounting a chipset on a device, without a separate base station or relay equipment, (2) provides seamless interoperability for a user and a developer with an aim of meeting Internet needs such as security, two-way communication, mobility, and localization services, (3) communicates no less than 10 km with minimum power consumption.

Unlike communications that require high-speed, broadband network equipment, LoRa requires no separate base station or relay equipment.

LoRa may transmit and receive data by directly mounting a chip on the device.

LoRa is the communication having lower infrastructure costs compared to 3G or LTE and, at the same time, highly scalable service.

Bluetooth, Zigbee, and the like, which are widely used not only for home use but also for industrial use, are low-power wireless communication protocols with low cost for modules and equipment but offer only short-range services, thereby causing a lot of expenses to extend the service range. In addition, Bluetooth, Zigbee, and the like are vulnerable to security.

A WirelessHart protocol has complemented shortcomings of such technologies and added a field bus function, but there is a problem that the supply of communication modules and equipment is very limited and expensive. In addition, the WirelessHart protocol has a disadvantage of incurring very high additional costs for service maintenance.

The LoRa technology has a wide communication range and an advantage that the battery life of the terminal is maintained several years due to low power consumption. In addition, the LoRa technology may lower infrastructure deployment costs as many access points (AP) and repeaters are not needed and provide cost efficiency and high scalability compared to 3/4G cellular networks.

The communication module used for the LoRa communication may be configured to use a COTEX M3-STM32F chipset as a main controller.

Cortex-M3 is a 32-bit processor. The 32-bit processor has a 32-bit data path and a 32-bit register bank interface and has a separate bus interface, whereby the 32-bit processor may not have more than 8 GB of memory. Thus, the Cortex-M3 uses Micro Processor Units (MPU) for complex applications, may use external caches as needed, and provides various interfaces.

A product family of the STM32 is designed to allow various applications to be available for MCU users. Accordingly, the product family is a 32-bit product that combines very high performance, real time functionality, digital signal processing, and low power and low voltage operation while maintaining the advantages in that integration and development are easy. In addition, the product family is based on an industry standard core and is provided together with various tools and software.

At this time, the communication module used for the LoRa communication may use a STM32F207VET6 chipset as a main controller, and the STM32F207VET6 chipset uses a real time memory accelerator (ART accelerator) and a multilayer bus matrix and an advanced NVM 90 nano process technology. The ARM Cortex-M3-based microcontroller is excellent in performance over price.

In addition, the communication module complies with LoRaWAN specification standard in the LoRa Alliance.

LoRa has developed LoRaWAN technology, which is low power wide area (LPWA) wireless communication technology, along with standards.

LoRaWAN is a media access control (MAC) protocol for broadband networks. LoRaWAN is designed to allow low power devices to communicate with application programs connected to the Internet via long-distance wireless connections. LoRaWAN may be mapped to the second and third layers of the OSI model. LoRaWAN is implemented on the basis of LoRa or FSK modulation in the industrial, scientific, and medical (ISM) radio band. The LoRaWAN protocol is defined by the LoRa Alliance and formalized in the LoRaWAN specification.

The communication module is configured to use an application data format based on the Fport of the LoRa protocol.

The transmitter 100 is configured to use 900 MHz Private LoRa communication when transmitting and receiving data.

When the 900 MHz Private LoRa communication is used, communication distance of about 15 to 20 km may be secured at sea.

The transmitter 100 is configured to have a beaconing function.

The receiver 200 is configured to calculate the moving distance of the sea current, the moving speed of the sea current, and the moving direction of the sea current on the basis of the GPS data received from the transmitter 100.

The GPS data may include time information when the data is obtained and position (GPS) information of the receiver 200. On the basis of the time information and the position information, the moving distance of the sea current, the moving speed of the sea current, and the moving direction of the sea current may be calculated.

In addition, the receiver 200 may store the GPS data.

The display unit 300 is configured to display the information related to the GPS data, the moving distance of the sea current, the moving speed of the sea current, and the moving direction of the sea current, so that the user may visually see the information.

The display unit 300 may display information obtained by the receiver 200, information stored in the receiver 200, and information calculated by the receiver 200.

The transmitter 100 of the sea current measuring device for the survivor according to an embodiment of the present invention may be equipped with a plurality of GPS units.

The transmitter 100 may be equipped with a plurality of GPS for each transmitter 100 and, in this case, may generate one GPS data on the basis of a plurality of GPS information obtained by the plurality of GPS units.

This is to reduce an error generated in the GPS, and, provided the plurality of GPS units is mounted, the error may be reduced by the average value and the like.

In addition, when any one of the GPS data has a difference no less than a predetermined level compared to the other values, it is determined that the corresponding GPS has failed, and the GPS data may be generated excluding the corresponding data.

The receiver 200 of the sea current measuring device for the survivor according to an embodiment of the present invention is configured to receive the GPS data from the plurality of transmitters 100 and, on the basis of the GPS data received, to calculate the moving distance of the sea current, the moving speed of the sea current, and the moving direction of the sea current.

That is, the plurality of transmitters 100 may be floated on the surface of the accident scene, and, by analyzing movements thereof, the moving distance of the sea current, the moving speed of the sea current, and the moving direction of the sea current may be calculated.

A reason for floating the plurality of transmitters (100) on the surface of the sea water is to identify general sea current flow, because the local sea current flow may be changed according to situations to an extent that prediction thereof is difficult.

The receiver 200 may receive GPS data from the plurality of transmitters 100 using a peer-to-multipeer (PtmP) scheme.

The receiver 200 of the sea current measuring device for the survivor according to an embodiment of the present invention is configured to calculate the moving distance of the sea current, the moving speed of the sea current, and the moving direction of the sea current with an average value of the GPS data received from the plurality of transmitters 100.

The receiver 200 may calculate the moving distance of the sea current, the moving speed of the sea current, and the moving direction of the sea current with an average value of GPS data in the same time zone.

This is to identify the general sea current flow.

The receiver 200 of the sea current measuring device for the survivor according to an embodiment of the present invention is configured to assign a weighting to the GPS data according to an extent of density of the transmitters 100 and to calculate the moving distance of the sea current, the moving speed of the sea current, and the moving direction of the sea current.

The receiver 200 may assign a higher weighting to a dense side according to an extent of density of the transmitters 100 among the GPS data of the same time zone and, on the basis of the weighting, may calculate the moving distance of the sea current, the moving speed of the sea current, and the moving direction of the sea current.

At this time, the data assigned with a weighting less than a preset value may be deleted.

This is to identify the sea current flow along which the survivor is more likely to be moved, from a probabilistic point of view.

The receiver 200 of the sea current measuring device for the survivor according to an embodiment of the present invention is configured to allow the collected information and the calculated information to be converted and linked to electronic navigation chart data.

This is to allow the corresponding information to be displayed on the electronic navigation chart, so that the information may be obtained through the electronic navigation chart.

The electronic navigation chart, in a wide sense, refers to a maritime geographic information data system that integrates all the information related to navigation of the vessel, that is, nautical chart information, location information, a ship's course, speed, water depth data, and the like and displays the integrated information on the computer screen that is for the navigation. In a narrow sense, the electronic navigation chart refers to a digital nautical chart that contains contents, structures, and formats standardized for use in Electronic Chart Display and Information System (ECDIS) by a national authority responsible for waterway operations.

The electronic navigation chart includes all the nautical chart information necessary for safe navigation and may even include additional information necessary for safe navigation in addition to those included on paper nautical charts.

In particular, by being connected to an automatic navigation system and a port control system under computer control, the electronic navigation chart plays important roles in the voyage of the vessels (1) to prevent marine accidents in advance, such as warning the navigator of dangerous situation about stranding and collision of the vessels in advance, (2) to provide information for selecting an optimal route, thereby increasing the marine traffic handling capability along with saving transport expenses, and (3) to enable the identification of the cause in the case of an accident through automatic track record.

The receiver 200 of the sea current measuring device for the survivor according to an embodiment of the present invention is configured to transmit electronic navigation chart data to an external terminal, and the external terminal is configured to visually display the electronic navigation chart data (see FIG. 2).

Here, any device, as long as being capable of communicating with the receiver 200, such as a PC, a tablet, a smartphone, a mobile device, and the like and of expressing information on a screen, may be applied as the external terminal.

That is, the external terminal may check information for survivor rescue on the land (a central control center and the like), on the sea (a vessel and the like), in the air (a helicopter and the like), or the like.

It takes a certain time to float the transmitters 100 on the water surface and to measure the sea current, and when the sea current measurement is completed, the transmitters 100 that moved by drifting during working time is to be retrieved. In this case, when the number of the transmitters 100 to be retrieved is large, it may take a long time to retrieve all of the transmitters, thereby delaying the time required to move to the next point.

In order to minimize the delay time, as shown in FIG. 3, the transmitter 100 of the sea current measuring device for the survivor according to an embodiment of the present invention is configured to be provided with a buoy part 110 at a bottom side thereof, wherein a drone part 120 is provided on a position above the buoy part 110.

The buoy part 110, serving as a buoy, is provided to be able to float on the water surface so that the drone part 120 is not submerged into the water.

The drone part 120 is to allow the transmitter 100 to move by being flown, and a drone provided with a propeller 121 may be used.

In this case, the propeller 121 may be configured not to allow the buoy part 110 to locate below the propeller in a vertical direction.

This is to prevent the buoyancy from being reduced by reducing the wind pushing down to the buoy part 110 by the propeller 121.

That is, the transmitter 100 may fly, thereby moving.

The drone part 120 may be used to float the transmitter 100 on the water surface and may also be used to retrieve the transmitter.

That is, when the transmitters 100 are to be floated in a certain arrangement, to float the transmitters using a vessel, it takes a long time and it is difficult to accurately match the arrangement. However, when group control is performed using the drone, it is easy to arrange the transmitters 100 in a predetermined arrangement, and the time to take for the arrangement may be reduced. In addition, the time to take to retrieve the transmitters 100 may also be reduced.

The drones may be classified into a bicopter (two propellers), a quadcopter (four propellers), a hexacopter (six propellers), an octocopter (eight propellers), and the like according to the number of propellers.

Some drones have three propellers, but a tricopter floats in the air in a similar way to the bicopter.

A reason why the number of propellers attached to the drone is even is that Newton's third law of action and reaction is to be used.

To describe with a quadcopter with four propellers attached thereto, as a reference, one pair of propellers facing each other rotate clockwise and another pair rotate counterclockwise, thereby allowing a constant altitude to be maintained and a floating hovering to be performed, by the principle of action and reaction.

When rear propellers are forced to rotate at a faster speed than front ones, the drone may move forward.

As lifting force, that is, force to lift, of a side where propellers rotate slowly, becomes small, and lifting force of a side where propellers rotate quickly becomes large, a drone becomes to tilt forward. At this time, the drone becomes to go forward as the lifting force becomes to face rearward according to the principle.

When two right propellers are forced to rotate at a faster speed than two left propellers, lifting force of a right side becomes larger, whereby the drone becomes to move leftward.

On the contrary, when the left side becomes to have larger lifting force than the right side by forcing to rotate the left propellers faster, the drone becomes to move rightward.

In this case, the transmitter 100 is configured to have a center of gravity lower than a center of buoyancy.

To this end, a battery 111 configured to supply power to the drone part 120 may be provided at a bottom of the buoy part 110, and a buoyancy portion 112 may be provided at a position above the battery 111 while enveloping the battery 111.

The buoyancy portion 112 may be filled with a material (solid (Styrofoam and the like) or liquid) having a lower density than water, or gas.

A body 122 of the drone part 120 and the battery 111 may be connected to each other through a frame 130 of a pipe shape.

That is, the body 122 of the drone part 120 and the battery 111 are fixed to the frame 130, and the wires may be wired in the internal space of the frame 130, whereby the power of the battery 111 may be supplied to the drone part 120.

The present invention is not limited to the above-described embodiments, the scope of application is various, and various modifications may be made without departing from the gist of the present invention as claimed in the claims.

What is claimed is:

1. A sea current measuring device for a survivor, the device comprising:
a transmitter (100) configured to transmit GPS data obtained from GPS mounted thereon using LoRa (Long Range) communication;
a receiver (200) configured to calculate a moving distance of the sea current, moving speed of the sea current, and a moving direction of the sea current on the basis of the GPS data received from the transmitter (100); and
a display unit (300) configured to display information related to the GPS data, the moving distance of the sea current, the moving speed of the sea current, and the moving direction of the sea current, thereby allowing a user to visually see the information.

2. The device of claim 1, wherein the transmitter (100) is equipped with a plurality of GPS units.

3. The device of claim 1, wherein the receiver (200) is configured to receive the GPS data from the transmitter (100) and, on the basis of the GPS data, to calculate the moving distance of the sea current, the moving speed of the sea current, and the moving direction of the sea current.

4. The device of claim 2, wherein the receiver (200) is configured to calculate the moving distance of the sea current, the moving speed of the sea current, and the moving direction of the sea current with an average value of the GPS data received from a plurality of transmitters (100).

5. The device of claim 2, wherein the receiver (200) is configured to assign a weighting to the GPS data according to an extent of density of the transmitters (100), thereby calculating the moving distance of the sea current, the moving speed of the sea current, and the moving direction of the sea current.

6. The device of claim 2, wherein the receiver (200) is configured to enable collected information and calculated information to be converted and linked to electronic navigation chart data.

7. The device of claim 6, wherein the receiver (200) is configured to transmit the electronic navigation chart data to an external terminal, and the external terminal is configured to visually display the electronic navigation chart data.
